(19) United States
(12) Patent Application Publication
(10) Pub. No.: US 2007/0033210 A1
(43) Pub. Date: Feb. 8, 2007

(54) Application data interaction method and system using an interaction manager

(75) Inventors: Daniel A. Baudino, Lake Worth, FL (US); Deepak P. Ahya, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/195,385

(22) Filed: Aug. 2, 2005

(51) Int. Cl. G06F 7/00

(52) U.S. Cl. 707/102

(57) ABSTRACT

An interaction data manager system (20) and method (400) can include an interaction data manager (17) capable of interacting with a plurality of applications (32) and one or more databases (18) and a processor (36). The processor can be programmed in accordance with the interaction data manager to link information from the plurality of applications, search the one or more databases for relevant data associated with application data currently being used, determine a relevance between the relevant data and the application data, and present the relevant data based on a relevancy of the relevant data. The system can be a portable communication product and the plurality of applications can one or more mobile phone applications among a call application, a messaging application, a phone book application, a date book application, an audio presentation application, a video presentation application, or an audio-visual presentation application.

### FIELD OF THE INVENTION

This invention relates generally to software interfaces, and more particularly to a method and system for application interaction.

### BACKGROUND OF THE INVENTION

Applications on a mobile phone generally do not interact with the each other. For example, a date book only accepts events and gives alerts fed back to the user. There is no interaction between internal phone applications and the collective knowledge available at a mobile phone or other computing device is not utilized to assist a user in remembering or linking important related data.

### SUMMARY OF THE INVENTION

Embodiments in accordance with the present invention can collect information about a person or event from a first application, store this information in a common database or in commonly accessible databases and then access and provide this information to a user when that user is engaged with a second application and an event or marker is activated in the second application that is related to the stored information.

In a first embodiment of the present invention, a method of application data interaction can include the steps of activating an application that uses application data found in one or more databases, generating associations with the application data using related data used with other applications, determining a relevance of the related data to the application data, and presenting the related data during operation of the application based on a relevancy of the related data to the application data. The application can be for example any mobile phone applications such as a call application, a messaging application, a phone book application, a date book application, an emailing application, a recent call list application, an audio presentation application, a video presentation application, or an audio-visual presentation application. Relevance can be determined by determining among a time relevance, a task relevance, an event relevance, and an update relevance. Relevance can also be determined by assigning an importance level to the relevant data based on one among a due date, a task termination date, and a previous update date. Presenting can be done by either visibly displaying or audibly presenting and such presentation can be done in an unobtrusive manner to the application running.

In a second embodiment of the present invention, an interaction data manager system can include an interaction data manager capable of interacting with a plurality of applications and one or more databases and a processor. The processor can be programmed in accordance with the interaction data manager to link information from the plurality of applications, search the one or more databases for relevant data associated with application data currently being used, determine a relevance between the relevant data and the application data, and present the relevant data based on a relevancy of the relevant data. The system can be a portable communication product and the plurality of applications can be at least one or more among mobile phone applications selected from a call application, a messaging application, a phone book application, a date book application, an emailing application, a recent call list application, an audio presentation application, a video presentation application, and an audio-visual presentation application. The processor can determine a relevance by determining at least one among a time relevance, a task relevance, an event relevance, and an update relevance. The system can further include a display that presents the relevant data such as icons that can be programmed to fade in accordance with a level of relevance as determined by the processor. The system can further include a speaker where the processor presents the relevant data audibly on the speaker. Note, the interaction manager can further include a database manager that links information and determines the relevance of the relevant data to the application data.

In a third embodiment of the present invention, a mobile communication device having an interaction data manager system can include a transceiver, an interaction data manager capable of interacting with a plurality of applications and one or more databases, and a processor coupled to the transceiver. The processor can be programmed in accordance with the interaction data manager to link information from the plurality of applications, search the one or more databases for relevant data associated with application data currently being used, determine a relevance between the relevant data and the application data, and present the relevant data based on a relevancy of the relevant data.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of an interaction manager system in accordance with an embodiment of the present invention.

FIG. 2 is block diagram of an integration manager system using a single or common database in accordance with an embodiment of the present invention.

FIG. 3 is a block diagram of an integration manager system including an integration manager and a database manager in accordance with an embodiment of the present invention.

FIG. 4 is a block diagram illustrating how a phone book entry interacts with the interaction manager in accordance with an embodiment of the present invention.

FIG. 5 is a block diagram illustrating how a date book entry interacts with the interaction manager in accordance with an embodiment of the present invention.

FIG. 6 is a block diagram illustrating how incoming call application interacts with the interaction manager in accordance with an embodiment of the present invention.

FIG. 7 is a block diagram illustrating how the interaction manager retrieves relevant data based on the relevancy of the application data in accordance with an embodiment of the present invention.

FIG. 8 is a flow chart illustrating a method of how relevance of the relevant data is determined in accordance with an embodiment of the present invention.

FIG. 9 is an illustration showing how a calling application and a date book application (as well as a visual and/or audible application) can share information to remind a user of an important event related to the party being called.

FIG. 10 is another illustration showing how a messaging application and a date book application can share information to remind a user of an important event such as an anniversary in accordance with an embodiment of the present invention.

FIG. 11 is an illustration of phone book browsing, sharing date book information with the phone book application, and receiving visual indication of such relevant information in accordance with an embodiment of the present invention.

FIG. 12 is another illustration of a phone book application that uses a fading icon to provide an unobtrusive reminder of an event and of its relevancy in accordance with an embodiment of the present invention.

FIG. 13 is an illustration of a date book interacting with a icon generating application to present icon entries to provide context and relevancy in accordance with an embodiment of the present invention.

FIG. 14 is a flow chart illustrating a method of application data interaction in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

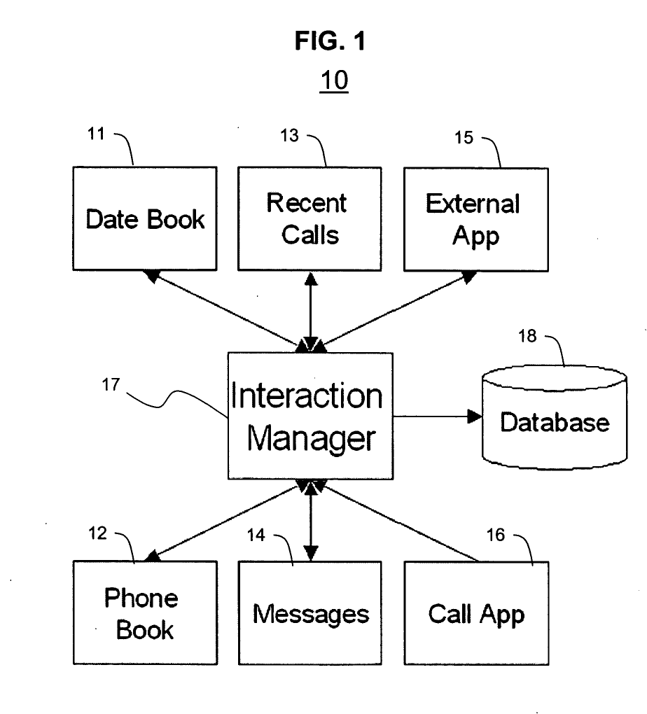

A specific example can best portray the usefulness of the embodiments herein with reference to FIG. 1. For example, if a user of a mobile radio device stores birthday information about a person in a contact or phone book application 12 and an application is called up such as an instant messaging (IM) application 14 where the instant messenger is the person in the phone book, the IM application 14 can search a common database 18 for information that is relevant to this person. If the person's birthday is relatively soon, the IM application 14 can signal the user of such event.

Embodiments herein can encompass a personal application framework or system 10 where all the applications existing on a phone for example can interact with each other through an interaction manager 17. The interaction manager 17 assists the applications to identify data generated from other applications. Applications in a mobile radio can include a date book or calendaring application 11, a phone book application 12, a recent call list or application 13, a messaging application 14 such as instant messaging or email, a call application 16, and other external applications such as cameras, video recorders, voice recognition, and location finding applications. For example, a date book entry might need to get a phone book entry to add it to the date book event manager. Each application has valuable information that other applications can benefit from.

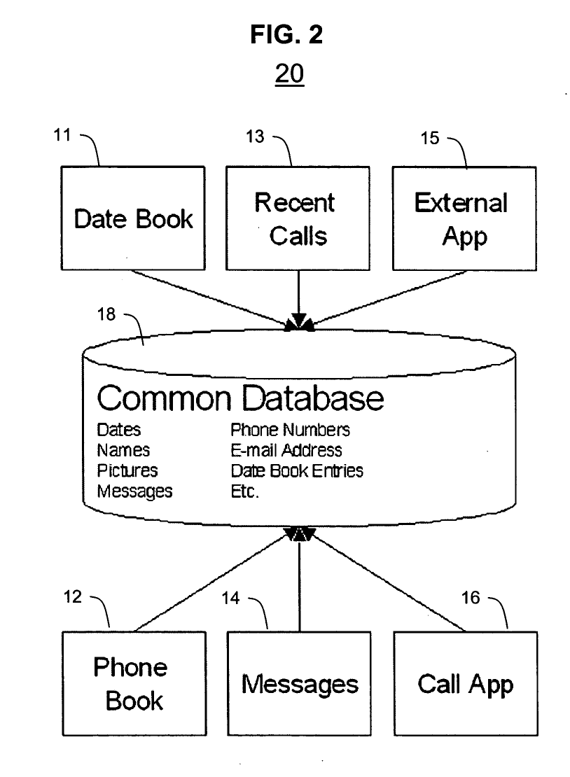

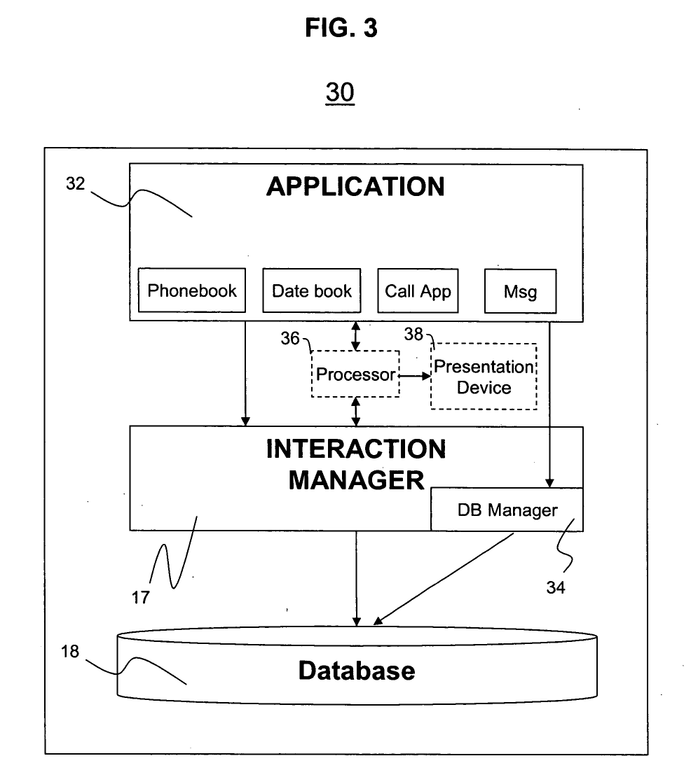

With reference to FIG. 2, a framework or system 20 can include the applications 11-16 and the common database 18 where all the data residing on the phone can be stored and accessed. The database 18 can be a common (single database) where all the applications share the same database, or it can be multiple databases where each application stores its own data in a different database. A database manager 34 as illustrated in the system 30 of FIG. 3 can belong to the Interaction Manager module 17. The database manager can be responsible to search or seek for the information of the multiple (or single) databases (18) and present it to the applications (32) and/or the Interaction Manager 17. Note, the system 30 can be a mobile radio or phone or other computing device having a processor 36 coupled to a presentation device 38 such as a display and/or speaker.

For the interaction to occur as described above, the database can include other fields such as:

| Entry | Description |
|---|---|
| Date Book entry | Appointments, events, etc |
| Link to another | i.e. Phone book entry. This entry can be |
| app/Association | manually entered or automatically generated |
| | from recent calls. |
| Person: | |
| Name | |
| DOB | Date of Birth or any other relevant day |
| | (this entry can be more than one - |
| | anniversary, etc) |
| Relationship | Wife/Husband/Mother/Father, friend etc |
| Significance | Enhance the relationship. Very good friends. |
| | Close relative, etc. |
| E-mail | |
| Link To media | Photo ID |
| Link to Other apps | The link could be date book entry etc. |
| Media | |
| Pictures | |
| Songs | |
| Voice Notes | |
| Messages | |
| Text | |
| Link to contacts | |
| Etc. | |

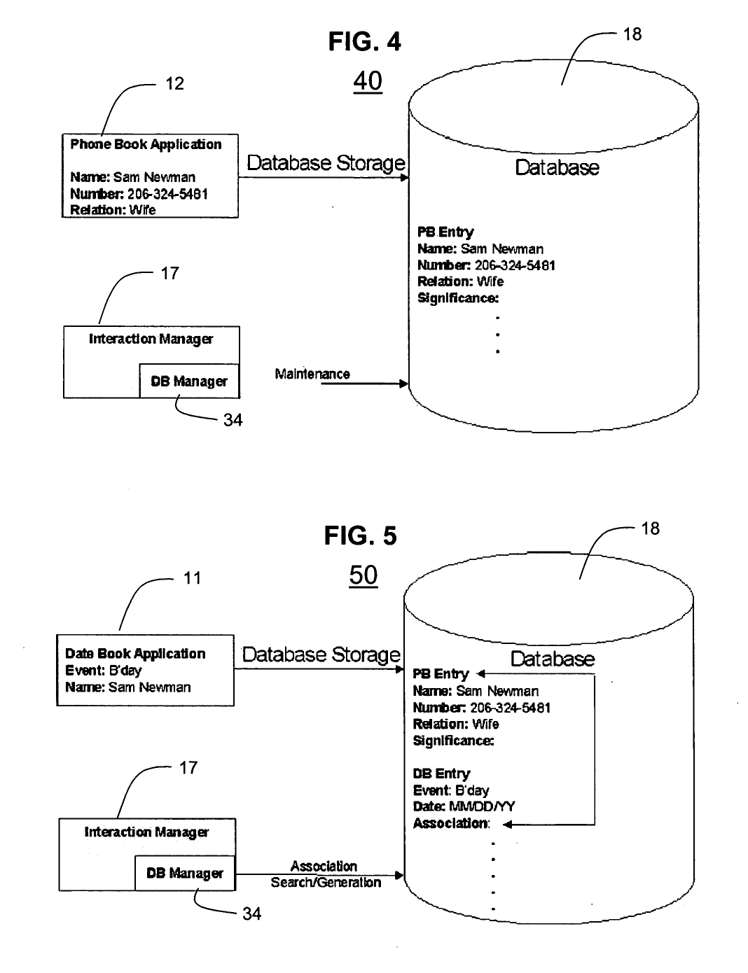

Again, another example can better illustrate how an interaction framework/architecture 40 as shown in FIG. 4 operates. The framework 40 shows how the phone book application 12 stores a single entry to the database 18. The entry can be provided manually by a user of a device such as a mobile radio. The database (DB) manager 34 of the interactive manager 17 generates a significance entry automatically or manually (i.e, wife=high significance).

Referring to FIG. 5, a framework 50 illustrates how a manual date book entry is entered and interactively managed. The DB Manager 34 searches the whole database 18 for associations, and creates a link when an association is being identified.

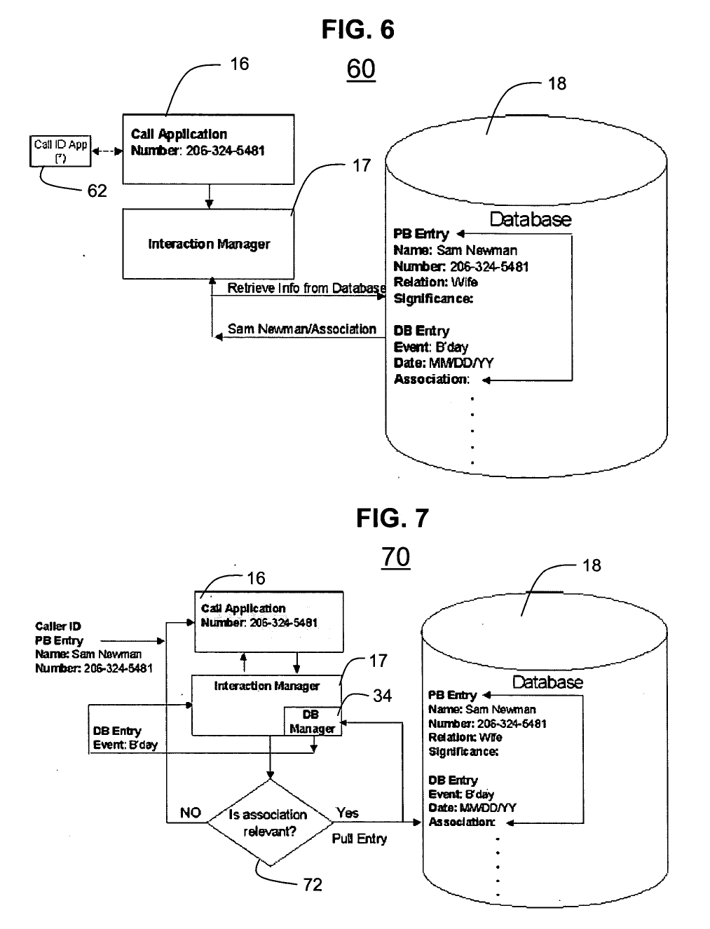

Referring to FIG. 6, a framework 60 illustrates how the interaction manager 17 operates when receiving a call using a call application 16 that utilizes a caller ID application 62. The Call application 16 requests Caller ID information from the Caller ID application 62 and forwards such information to the interaction manager 17. The interaction manager 17 pulls or retrieves the phone book record from the database 18, and checks to see if there is an association. If an association exists, then the interaction manager 17 pulls the association (together with the phone book entry). In this instance, the Caller ID application 62 is used to do the search on the Phone book Database.

Referring to the framework 70 of FIG. 7, once the association is pulled, the interactive manager 17 can check the relevance of it. If the association is relevant (today is the date, week, etc) as determined at decision block 72, then the database manager 34 retrieves the Entry (associated with the PB entry). The interaction manager 17 can be responsible to create a reminder based on the association and send it to the application (e.g., a birthday of the caller is soon or today.)

Relevance is created when an association is identified. The relevance can be linked to the association either automatically or manually by the user. There are different types of relevance. Some personal examples can include the day of a birthday or an anniversary which would have high relevance, or a day or two before a birthday or anniversary which would have moderate relevance, and there can be low relevance a week or more before a birthday, anniversary or other important date. Other personal items of relevance can include tasks and memos. Some business examples can include important dates, tasks, memos and travel related relevance that can have high relevance on the week of departure for example.

Relevance can also be determined based on time, a task, an update, or on an event. Time Relevance is a relevance determined based on the time of an event. If the event has passed, then the relevance can be considered either low (depending on the importance of the event) or non-existent. If the event is today or soon (hours, minutes, etc.), then the relevance is high. Events in the future might have a relevance that would depend on the number of days until the event. With respect to “Task Relevance”, this relevance can depend on a task completion. An “Updates” Relevance can be a relevance associated with memos, messages, or other subject matter that have been previously received. The relevance can depend on the last time a version of the memo or message was last received. An “Event” relevance can be determined on the event, for example, if the event is “traveling on Friday”. The relevance is either high or moderate the whole week of the travel date. The data stored on the database 18 (events) can have expiration timers associated with them. The database manager 34 can be in charge of the database housekeeping including time expiration, event or task expiration, or manual entries from a user. Note, relevance and any type of association can be created during runtime of an application or when a device is idle.

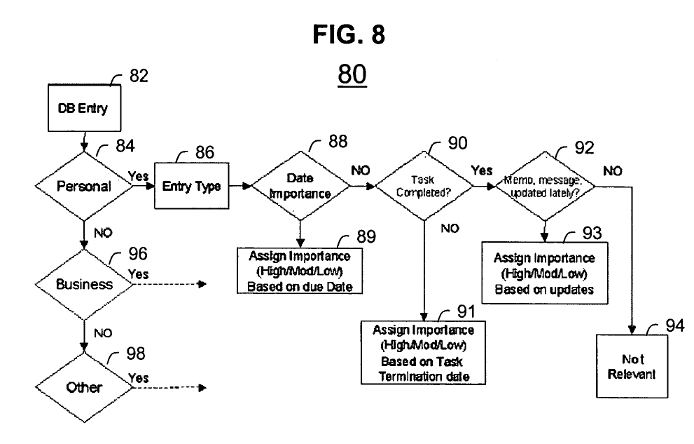

Referring to FIG. 8, it is shown how the relevance can be determined in accordance with a method 80. Upon entering a database entry at step 82, a determination is made whether the entry is or a personal nature at decision block 84, related to business at decision block 96, or related to other matters at decision block 98. Based on the entry type at block 86 whether it is related to a time at decision block 88, to a task at decision block 90, or an update at decision block 92, an importance is assigned respectively at steps 89, 91 or 93. If the entry type fails to match those listed above, then the database entry is assigned “no relevance” at step 94.

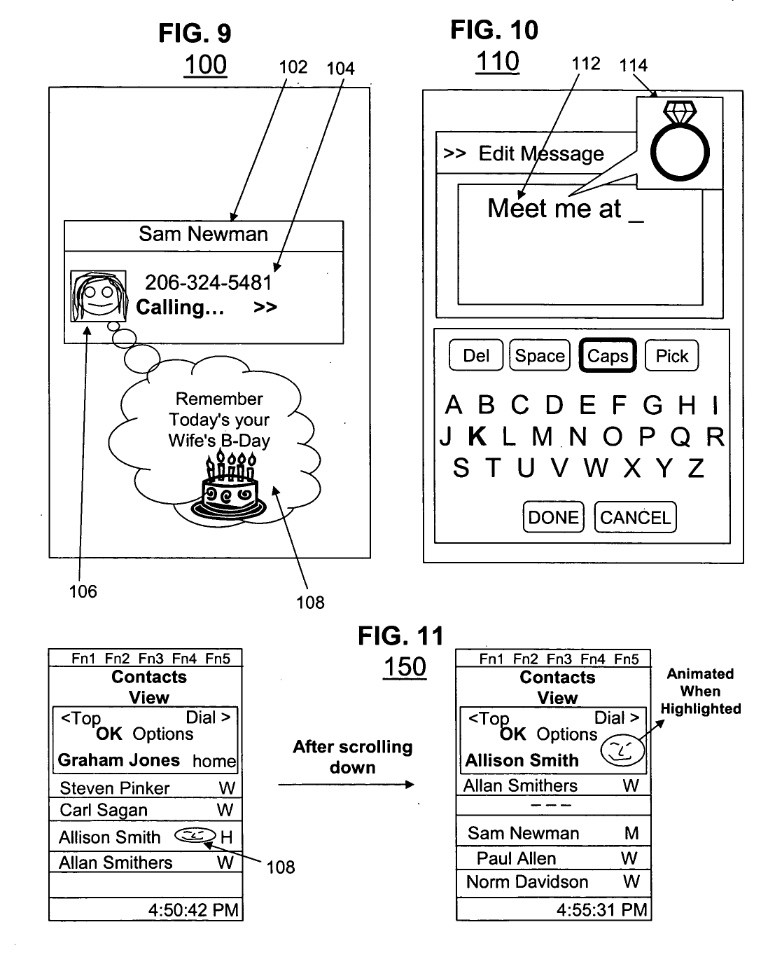

Several examples provided below can further illustrate the usefulness of the embodiments. With the use of new fields on a date book for example and the interaction with other applications, now the applications can check on a database to find related information. Before an action is performed, a device can alert the user with all the related/meaningful information found. In one example where a wife's birthday is imminent, a husband when making or receiving a phone call can cause the interaction manager 17 to query the database 18 with the Incoming/outgoing call phone number. The data base query would use the phone book as input and the output or information retrieved after the query would include today's date and the birth date of the called or calling party. All the applications can remind the husband/user that today is the wife's birthday when an action is required. As illustrated in the call screen 100 of FIG. 9, if the user makes/receives a phone call to the wife (having an associated name 102, phone number 104, and image 106), the call application can look into the date book and get informed that today is the wife's birthday, and display a friendly reminder in the form of an image 108. Before answering/making the call, the user can be made aware of the birthday so he is not taken by surprise. The same type of indication can be applied for a message application as illustrated by the message screen 110 of FIG. 10. When the user is writing a message 112, he or she can be reminded to add a note on the message being written about the birthday/anniversary, etc. via an indication 114 using an icon, text message, audible alert or other means.

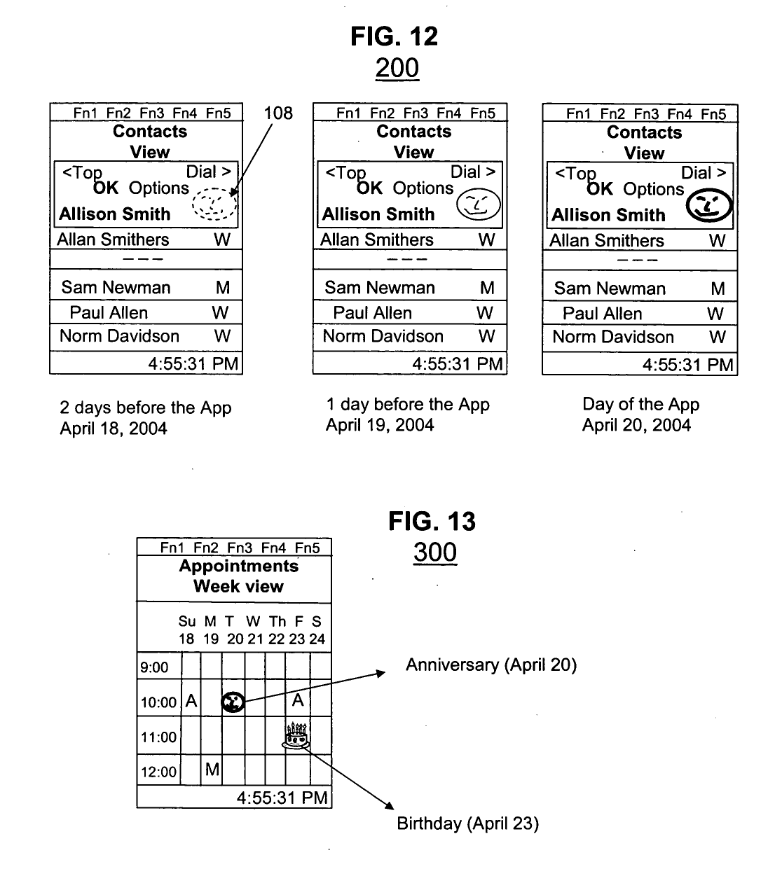

When browsing a phone book, a device can quickly remember all the events/reminder associated to a person. As a user navigates a phone book as illustrated in FIG. 11, a phone book entry associated to the user with an entry on the date book can show an icon representing a particular event such as an appointment. When the entry is highlighted after scrolling to the entry with the icon, the icon can animate or provide other indications as needed. In yet another alternative variation, FIG. 12 illustrates how an icon can appear faded a few days before an event is listed on the calendar and becomes more concrete as the day of the event approaches. This indication can give the user a passive reminder in advance in an unobtrusive manner. An unobtrusive manner can mean that a user is provided information without requiring any further affirmative actions by the user and/or without obscuring or diminishing the typical operation of the user interface. In a week view as shown in FIG. 13, several entries with icons can be shown to represent significant or relevant dates as appropriate.

The same techniques illustrated above can be used to remind a business user of a Business meeting. Besides the icon, a song can be associated with the phone book entry, or a ringtone can change automatically when the user receives a call on the day of the event from the phone book entry associated with the date book (the ring tone can be associated with the reminder—i.e. Birthday song).

The interaction manager can populate the date-book automatically by doing a simple query of the database. For example, the interaction manager can search for all existing dates of birth (DOB) on the database (phone books entries) and add them automatically to the date book, so when the day comes the user receives an alert. Also the interaction manager can do an Internet search to identify special days, such as Valentines Day, Father/Mother days, etc. Then, using the relationship field on the database, the Valentines day entry can be linked to the wife phone book, the Father's day entry can be linked to the father entry on the phone book, and so on. The user can activate the predetermined entries and edit those entries as he/she wishes.

The interaction manager can also do global queries if requested. For example when on a business call, the user might want to find out all the e-mails/messages interchanged with the caller, as well as phone book, important dates etc. All that information can be queried on the database and presented to the user. When the user receives a call, then all the important information is displayed to the user during the call (phone number, e-mail etc.), as well as links to other important information exchanged (appointments, emails, etc). During the call, the user can easily select and review all the relevant important information.

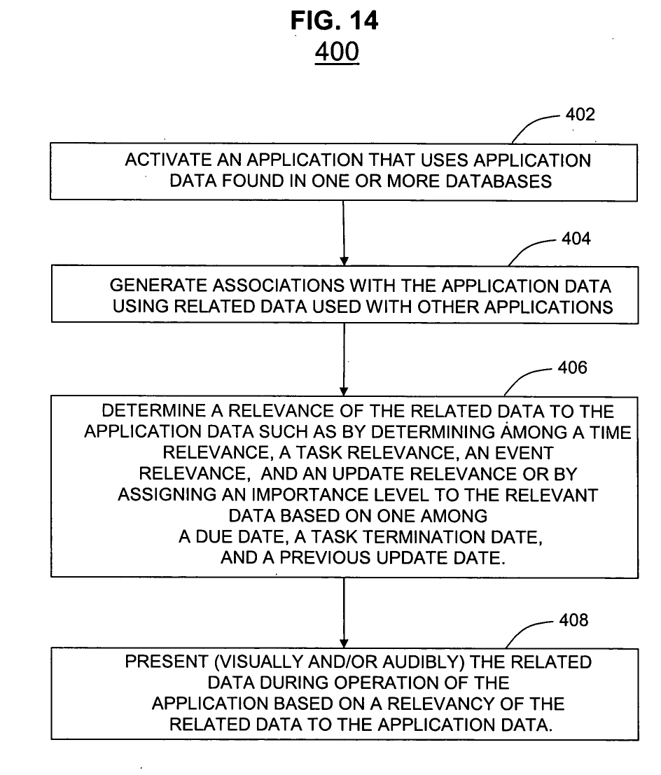

Referring to FIG. 14, a method 400 of application data interaction can include the step 402 of activating an application that uses application data found in one or more databases, generating associations with the application data using related data used with other applications at step 404, determining a relevance of the related data to the application data at step 406, and presenting at step 408 the related data during operation of the application based on a relevancy of the related data to the application data. The application can be for example any mobile phone applications such as a call application, a messaging application, a phone book application, a date book application, an emailing application, a recent call list application, an audio presentation application, a video presentation application, or an audio-visual presentation application. Relevance can be determined by determining among a time relevance, a task relevance, an event relevance, and an update relevance as noted in step 406. Relevance can also be determined by assigning an importance level to the relevant data based on one among a due date, a task termination date, and a previous update date also as noted in step 406. Presenting can be done by either visibly displaying or audibly presenting and such presentation can be done in an unobtrusive manner to the application running.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of application data interaction, comprising the steps of:
activating an application that uses application data found in one or more databases;
generating associations with the application data using related data used with other applications;
determining a relevance of the related data to the application data; and
presenting the related data during operation of the application based on a relevancy of the related data to the application data.

2. The method of claim 1, wherein the application is selected among mobile phone applications comprising a call application, a messaging application, a phone book application, a date book application, an emailing application, a recent call list application, an audio presentation application, a video presentation application, or an audio-visual presentation application.

3. The method of claim 1, wherein the step of determining the relevance comprises determining a time relevance, a task relevance, an event relevance, or an update relevance.

4. The method of claim 1, wherein the step of determining the relevance comprises assigning an importance level to the relevant data based on a due date, a task termination date, or a previous update date.

5. The method of claim 1, wherein the step of presenting comprises the step of visibly displaying or audibly presenting.

6. The method of claim 5, wherein the step of presenting the related data is done in an unobtrusive manner to the application.

7. An interaction data manager system, comprising:
an interaction data manager capable of interacting with a plurality of applications and one or more databases; and
a processor programmed in accordance with the interaction data manager to:
link information from the plurality of applications;
search the one or more databases for relevant data associated with application data currently being used;
determine a relevance between the relevant data and the application data; and
present the relevant data based on a relevancy of the relevant data.

8. The system of claim 7, wherein the system further comprises a portable communication product.

9. The system of claim 8, wherein the plurality of applications comprises mobile phone applications selected from a call application, a messaging application, a phone book application, a date book application, an emailing application, a recent call list application, an audio presentation application, a video presentation application, or an audio-visual presentation application.

10. The system of claim 7, wherein the processor determines a relevance by determining a time relevance, a task relevance, an event relevance, or an update relevance.

11. The system of claim 7, wherein the system further comprises a display and the processor presents the relevant data on the display.

12. The system of claim 11, wherein the processor is further programmed to provide icons on the display that fade in accordance with a level of relevance.

13. The system of claim 7, wherein the system further comprises a speaker and the processor presents the relevant data audibly on the speaker.

14. The system of claim 7, wherein the interaction manager further comprises a database manager that links information and determines the relevance of the relevant data to the application data.

15. An mobile communication device having an interaction data manager system, comprising:
a transceiver;
an interaction data manager capable of interacting with a plurality of applications and one or more databases; and
a processor coupled to the transceiver and programmed in accordance with the interaction data manager to:
link information from the plurality of applications;
search the one or more databases for relevant data associated with application data currently being used;
determine a relevance between the relevant data and the application data; and
present the relevant data based on a relevancy of the relevant data.

16. The mobile communication device of claim 15, wherein the plurality of applications comprises at least one or more among mobile phone applications selected from a call application, a messaging application, a phone book application, a date book application, an emailing application, a recent call list application, an audio presentation application, a video presentation application, or an audio-visual presentation application.

17. The mobile communication device of claim 15, wherein the processor determines a relevance by determining a time relevance, a task relevance, an event relevance, or an update relevance.

18. The mobile communication device of claim 15, wherein the mobile communication device further comprises a display and the processor presents the relevant data on the display.

19. The mobile communication system of claim 18, wherein the processor is further programmed to provide icons on the display that fade in accordance with a level of relevance.

20. The mobile communication system of claim 15, wherein the mobile communication device further comprises a speaker and the processor presents the relevant data audibly on the speaker.
